(19) United States
(12) Patent Application Publication
(10) Pub. No.: US 2009/0320409 A1
(43) Pub. Date: Dec. 31, 2009

(54) Method and Device for Bundling Steel Coils and Binding Tape for this

(76) Inventors: Franz Dorninger, Katsdorf (AT); Hans-Jürgen Zeiler, Linz (AT)

Correspondence Address: PAULEY PETERSEN & ERICKSON, 2800 WEST HIGGINS ROAD, SUITE 365, HOFFMAN ESTATES, IL, 60169, US

(21) Appl. No.: 11/992,984

(22) PCT Filed: Aug. 4, 2006
(86) PCT No.: PCT/EP2006/007741

§ 371 Date: Sep. 11, 2009

(30) Foreign Application Priority Data
Oct. 7, 2005 (DE) 102005048238.4

(51) Int. Cl. B65B 13/02; B32B 5/02; B65B 13/32

(52) U.S. Cl. 53/399; 428/113; 53/582; 100/12

(57) ABSTRACT

The invention relates to a method for bundling or strapping objects, in particular steel coils, wherein a binding tape made of a composite material comprising continuous fibers and a thermoplastic material and having a width of from 10 to 50 mm and a thickness of from 100 to 300 μm is placed around the object, in particular the steel coil, thereby forming overlapping ends of the binding tape, and in the region of the overlapping ends heat is applied to the ends of the binding tape lying one on top of the other, in such a way that the thermoplastic material softens, and pressure is subsequently exerted over the surface area of the softened region in such a way that the ends of the binding tape are pressed against each other; the invention also relates to a device for carrying out the method and to a binding tape for this.

### FIELD OF THE INVENTION

The invention relates to a method and a device for bundling steel coils and a binding tape for this.

### BACKGROUND OF THE INVENTION

In the steel industry, after the casting process, the warm band that has been rolled from slabs is wound into large coils at the end of the rolling process. For the manufacture of cold-rolled fine plates, after this hot-rolling process, the cold-rolling process is carried out in steel band thicknesses of usually 0.3 to 3 mm. After the cold-rolling process, these fine-rolled steel plates are normally rolled into a packet or coil and then conveyed to a coating process, in particular for coating with corrosion-protection layers. In this case, the steel packets or coils are unrolled again and pass through the coating unit, for example a hot dip unit, an electrolytic galvanizing unit, a phosphatizing unit, and the like.

After the steel band has passed through this coating unit, it is rolled up once more to form a steel packet or coil.

To prevent these steel packets or coils from inadvertently coming unwound during transport or storage in the steel mill, for example from a rolling line to a coating line or during storage before being shipped to the customer, and while on the customer's premises, and also in order to prevent the free ends of the steel band from protruding out from the coil, such steel packets or coils are provided with tightening straps for preventing the coil from coming undone.

In the steel industry, so-called steel binding tapes are used for this purpose due to the high weight of the coil. These steel binding tapes (FIG. 20) usually have a width of 25.4 mm and a thickness of 0.8 mm. In order to produce a binding, these steel binding tapes are placed around the coil at the end of the respective process and after the winding of the steel packet or coil; they are tensioned with a corresponding machine and then a closure (FIG. 20) is produced in the overlap region. The closure in this case can be composed of a so-called clasp; this is a steel plate that is placed radially around the region to be clasped and is then pressed onto the clasping region; a so-called crimping is carried out in which, in a fashion similar to a bead joining process, the materials of the clasp and the two binding tape ends are pressed into each other and displaced or notched in relation to each other.

Another possibility is comprised of fastening the ends of the binding tape to each other by means of a spot weld or fastening them without a clasp in a fashion similar to a simplified interfusing.

These steel binding tapes have tensile strengths of approximately 1,000 MPa.

These steel binding tapes have a number of severe disadvantages. On the one hand, the steel binding tapes tend to recoil or jump out when opened as a result of the tension that they are under; even due to the weight of the steel binding tape and the elastic restoring forces, these steel binding tapes represent a considerable danger. In addition, they have relatively sharp lateral edges that frequently cut people who handle them. In one known case, the person whose job it was to open the coils was blinded by the recoil of the steel band. In summary, the steel binding tape is unsatisfactory from an accident and work safety standpoint.

On the other hand, the steel binding tape, in particular the clasp or the closure region in this case, produces so-called binding tape indentations in the wound coil, where the tape or the clasp makes indentations in the wound steel band. These binding tape indentations not only damage the first loop of the steel coil, but they frequently extend into the coil by as much as between 15 mm and 20 mm. This means that for example with fine plate, the first 15 to 25 loops, or up to 200 m of strap length of the coil are damaged. Particularly in outer skin plates, however, this cannot be tolerated in the processing operation. It is therefore customary for the first loops, which have been damaged by the binding tape indentations, to be cut off before processing, for example in a press shop, and to be sent back to the steel manufacturer.

Apart from the fact that it makes no sense from a material economic standpoint to ship material from a manufacturer to a processor and then back again, this also entails a much greater amount of work for the processor because it is impossible to say how many meters of the new band have actually been damaged. Consequently, it is first necessary to ascertain the damage, then to determine where the unwound steel band is to be cut, and finally to carry out the actual cutting. Out of 100,000 tons per year of shipped weight (transported mass), 10%, i.e. approx. 10,000 tons per year of scrap, is generated by these binding tape indentations.

It is essentially true that the thinner the fine plate, the higher the risk of damage due to binding tape indentations.

DE 40 07 560 C2 has disclosed a tightening strap closure for thermo-plastic tightening straps (but not for coils) and a method for manufacturing it; this tightening strap closure is intended to increase the peel-off strength of a closure of the ends of thermoplastic straps. In this case, the overlapping regions are attached to each other by means of a friction weld. The steps taken to increase the peel-off resistance of the overlapping parts are carried out on opposite sides of the welded connection; this can be a spot-welded connection outside the actual friction welded connection, or an embracing clamp made of wire or band can be placed at the ends of the welded connection, or a middle section can be produced, which is angled away from the strapped item in the travel direction of the tightening strap. The middle section is adjoined by a respective leading part and trailing part that extend parallel to the travel direction or else the overlapping tightening strap sections of the inner and outer surfaces that are welded to each other in the thermoplastic state are slightly separated before the hardening of the plastic; the thermoplastified plastic hardens, forming a honeycomb-shaped intermediate structure with a high peel-off strength.

Tests carried out by the applicant have shown that the thermoplastic straps that are well-known from the packing industry are not suitable for use as steel coil binding tape even if the above-mentioned steps are taken, because their tensile strengths are far from sufficient. The above-mentioned steps for increasing the peel-off strength end up producing binding tape indentations themselves.

DE 40 18 659 C2 has disclosed a friction welding device for producing a closure in a flexible thermoplastic tightening strap, with two reciprocally acting strap-grasping elements that are formed in complementary fashion to each other, between which reciprocally overlapping strap sections of the tightening strap can be accommodated and pressed together; each strap-grasping element has a contoured surface and one of the strap-grasping elements is provided with a drive unit for the friction welding movement; the surfaces of the strap-grasping elements have a wave-shaped curvature in the longitudinal direction of the strap, comprised of a convexly curved surface segment and a concavely curved surface segment; the strap ends of the two overlapping strap sections that are delimited by a cut-off incision each rest against the concavely curved surface segment of the strap-grasping elements and the strap-grasping element attached to the friction welding drive unit is horizontally movable transverse to the tightening strap.

Even with a device of this kind, it is not possible to produce a connection of a conventional plastic strap that would be sufficient for the demands placed on it.

The object of the present invention is to create a method for bundling steel coils that is easy, quick, and safe to carry out, produces a connection with a high load-bearing capacity, and does not produce binding tape indentations.

Another object of the present invention is to create a device for carrying out the method.

Another object of the present invention is to create a tightening strap, in particular for steel coils or steel packets (or other metal coils), which produces a strong connection with a sufficient tensile strength and breaking strength of the base material and in addition, does not produce binding tape indentations either with the base material or in the connecting region.

### SUMMARY OF THE INVENTION

The binding tape according to the present invention is composed of a high-strength composite material composed of continuous fibers that are oriented essentially parallel to one another and are contained in a thermoplastic matrix.

It has turned out that such a strap has a sufficient tensile strength if it has a width of 30 mm and a thickness of 200 μm.

For example, the fibers of the high-strength composite material are glass fibers, carbon fibers, aramide fibers, and all other known fibers for composite materials. Preferably, they are glass fibers.

The matrix is composed of a thermoplastic material; all conventional thermoplastic materials can conceivably be used, e.g. polyolefins or polyamides. Preferably, the matrix is composed of a polyamide.

The high-strength composite material of which the binding tape is produced is manufactured in very wide, large webs or sheets that are usually used to wind around containers for aviation or space flight. It is also known to thermoplastically shape large webs of this kind, for example by means of deep-drawing, in order to produce particularly lightweight, high-strength components. Webs of this kind are also used, for example, in vehicle body construction.

The method according to the invention provides for producing corresponding narrow belts or straps from the high-strength composite material, placing them around the steel coil, heating the overlapping regions, and pressing them into each other with high pressure. By contrast with a friction welded connection, which would damage the fiber composite material, in particular the fibers, and also contribute to an undesirable distribution of the matrix, the method according to the present invention results in the fact that in the region of the connection point, the thickness of 200 μm is not substantially exceeded; however, the matrix of the overlapping straps homogeneously intermingles and in addition, the fibers in this sensitive region achieve a particularly high packing density. This particularly high packing density makes it possible for the fibers to lie very snugly against one another so that the shearing forces occurring in the event of the tensile load are very favorably distributed among the fibers. It has also turned out that this connection produces no indentations even with a direct load.

The tightening strap according to the invention, which has been placed around a coil and fastened using the method according to the invention, has a sufficiently high strength, rendering it unnecessary to use more pieces of binding tape than before so that with a comparable price of the binding tape, no additional costs are incurred.

The device according to the invention grasps the strap ends or the strap ends are inserted into the device, a corresponding heating device brings a heated die against one or both sides of the overlapping strap ends, and with a pressure of at least 1 bar, welds the straps into one another.

With the method according to the invention, it is advantageous that a high-strength connection of the binding tape is produced easily, quickly, and safely, which connection is simultaneously so thin in the connecting region that despite a surprisingly high tensile strength, it does not produce any indentations.

With the binding tape according to the invention, it is advantageous that it is particularly thin and for this reason alone, does not produce any binding tape indentations; the tensile strength and shearing strength, however, are high enough that this binding tape fully meets the requirements placed on it. With the high-strength composite material, it is also advantageous that in the connecting region, when there are excessive tensile forces, the connection does not abruptly tear, but rather individual fibers are slowly pulled out one after another and a material that has been previously damaged in this way generally still has enough residual strength that it prevents the packet or coil from coming undone.

With the material used according to the invention, it is also advantageous that this material is particularly lightweight, does not have any sharp metallic edges, and upon opening, is not under such stress that it flies out when cut. This significantly reduces the danger of accident in comparison to conventional steel binding tapes.

The invention will be explained by way of example in conjunction with the drawings.

### BRIEF DESCRIPTION OF THE DRAWINGS

FIG. 1 schematically depicts a coil with a binding strap that is placed around it and has a device according to the invention placed onto it.

FIG. 2 is a section from FIG. 1 showing the device in a schematic cross section.

FIG. 3 is a very schematic depiction of the function of the device according to the invention.

FIG. 4 shows a first step in the manual strapping.

FIG. 5 shows a second step in the manual strapping, using a device according to the invention embodied in the form of a handheld unit.

FIG. 6 is a very schematic top view of a binding tape according to the invention.

FIG. 7 is a very schematic longitudinal section through a binding tape according to the invention.

FIG. 8a is a very schematic depiction of the overlapping and connecting region of the binding tape.

FIG. 8b shows the region according to FIG. 8a after the tensile test.

FIG. 9 is a stress/elongation graph of a steel binding tape.

FIG. 10 is a stress/elongation graph of a conventional plastic packing strap.

FIG. 11 is a stress/elongation graph of another plastic packing strap.

FIG. 12 is a stress/elongation graph of the binding tape according to the invention.

FIG. 13 is a table depicting the data from FIG. 9.

FIG. 14 is a table depicting the data from FIG. 10.

FIG. 15 is a table depicting the data from FIG. 11.

FIG. 16 is a table depicting the data from FIG. 12.

FIG. 17 is a table showing cross-sectionally corrected values for the binding tape according to the invention.

FIG. 18 is a table showing cross-sectionally corrected values for the plastic strap according to the invention.

FIG. 19 is a table showing cross-sectionally corrected values for the binding tape according to the invention.

FIG. 20 shows the closing region of a steel binding tape.

### DETAILED DESCRIPTION OF THE PREFERRED EMBODIMENTS

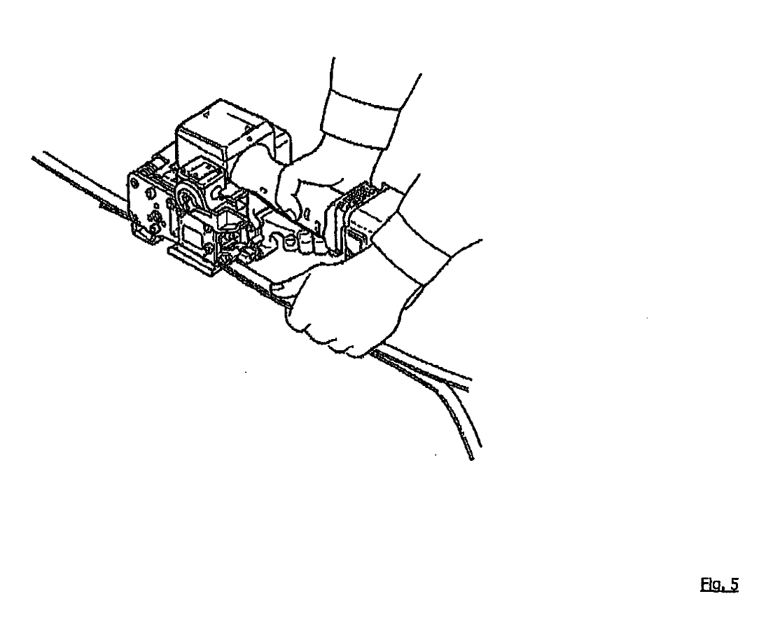

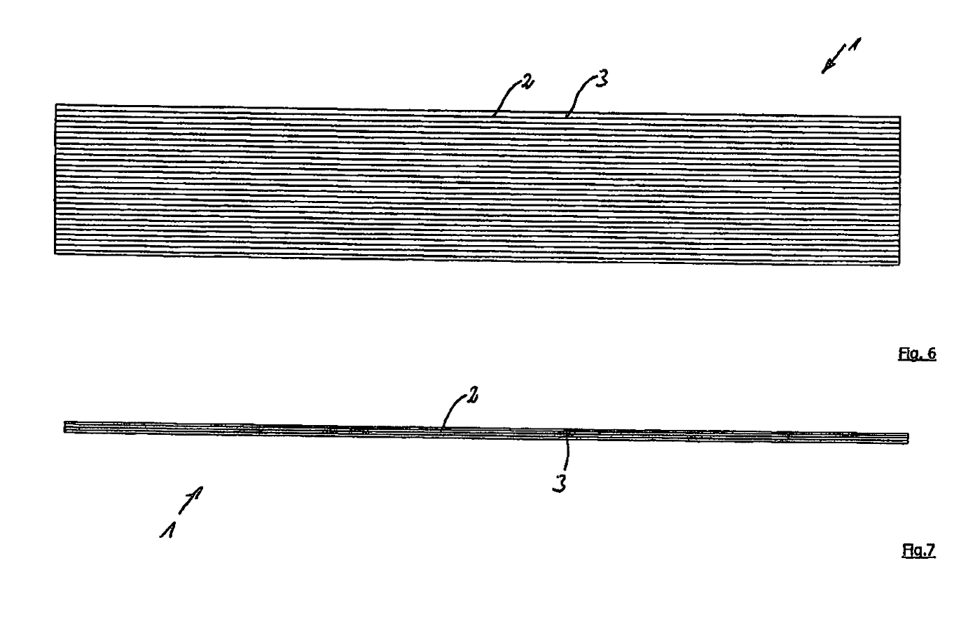

The binding tape 1 according to the invention (FIGS. 6 through 8b) is essentially composed of continuous fibers 2 in one or more layers that are embedded in a plastic matrix 3. The fibers in this case can be any conventional fibers that are used in composite materials. In particular, these can be glass fibers, carbon fibers, aramide fibers, or also natural fibers. Preferably, glass fibers are used. The matrix 3 is composed of a plastic, preferably a thermoplastic material such as a polyolefin or a polyamide.

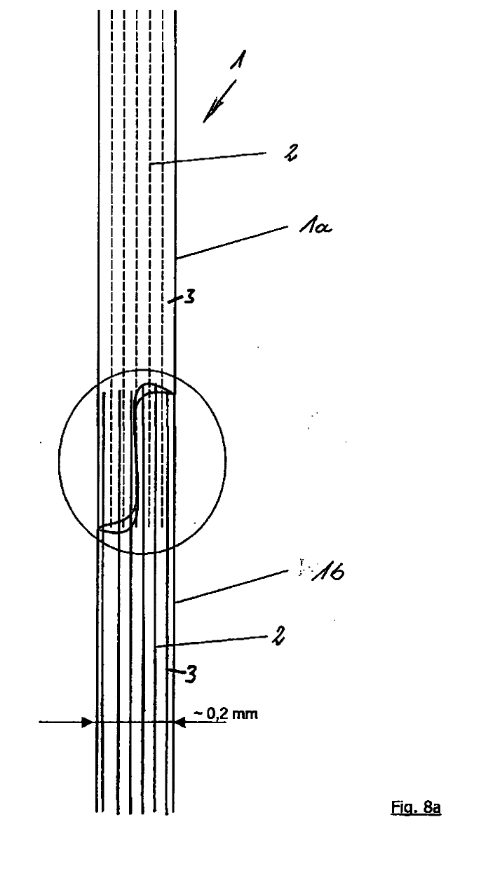

The binding tape 1 is relatively flat and has a width of for example 10 to 50 mm, in particular 25 to 40 mm, and preferably 30 mm, with a thickness of 150 to 400 μm, preferably 200 to 350 μm. In order to produce a connection of the binding tape (FIG. 8a), the corresponding binding tape ends 1a, 1b are pressed against each other and heated to temperatures of 150° to 500° C., preferably 200° to 400° C., in particular 350° C.; this heating temperature depends on the plastic used. This heating causes the plastic to plastify at which point it is possible to deform the plastic and to carry out the next step. After the plastic is sufficiently softened, pressure is exerted on the overlapping region of the binding tape. It is preferable to exert a pressure of 0.1 N/mm² to 10 N/mm², preferably 1 N/mm².

As is particularly visible in the very schematic depiction of FIG. 8a, this pressure presses the fibers 2 into one another in the region of the connecting point; the overall height of the binding tape remains essentially unchanged, but the number of fibers per unit area is increased in the region of the connecting point. The high number of fibers in the region of the connecting point allows the fibers to be favorably supported against one another upon exertion of tensile stresses and resulting shearing forces; the distance of the fibers from one another is very small and it is therefore possible for a very favorable transmission of force of the individual fibers to occur via the matrix because the matrix regions are relatively small.

If the tensile strength of the binding tape is exceeded (FIG. 8b), this does not cause an abrupt tearing to occur in the region of the connecting point, but instead causes the binding tape ends to progressively diverge in the region of the connecting point, with individual fibers being pulled out of the respective binding tape ends in the connecting region, permitting the strap to retain a certain amount of residual strength.

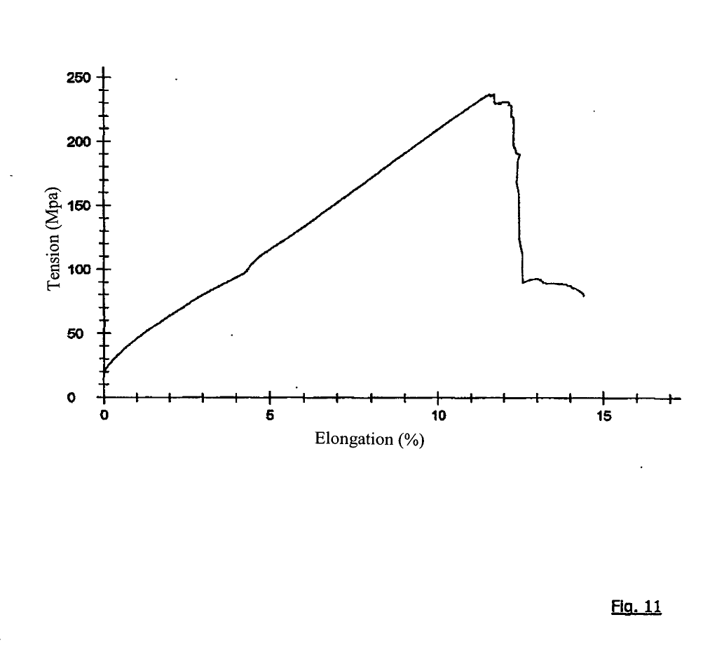

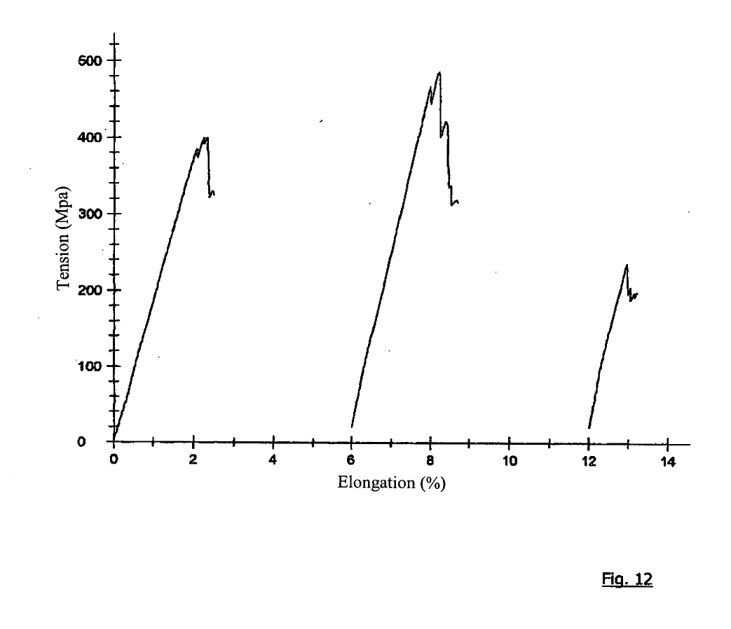

In tensile tests (FIG. 12), the binding tape according to the invention demonstrates a favorable behavior with regard to elongation. It is important for the binding tape not to stretch too much after being placed around a coil; this is easily achieved with the binding tape according to the invention. The binding tape elongates by amounts comparable to those of a steel binding tape. The three values shown in FIG. 12 represent, starting at the far left, the binding tape in the closed state; in this case, the binding tape tears in the region of a relatively well-made connection.

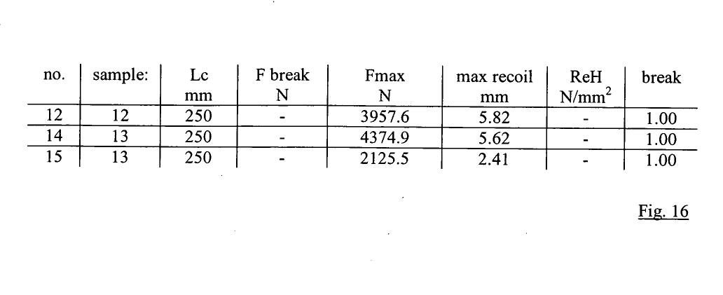

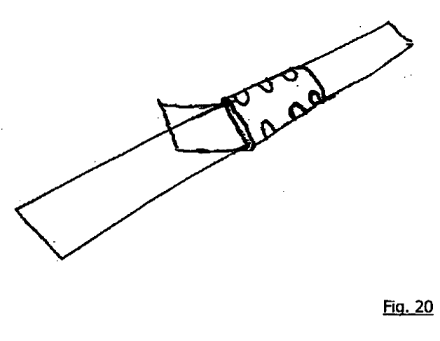

The middle curve shows the tearing of a binding tape in the region of the full material without a connection, and the curve at the far right depicts an intentionally poor connection. The corresponding values are reflected in the table in FIG. 16; in the table in FIG. 19, the relative strength is expressed in N/mm².

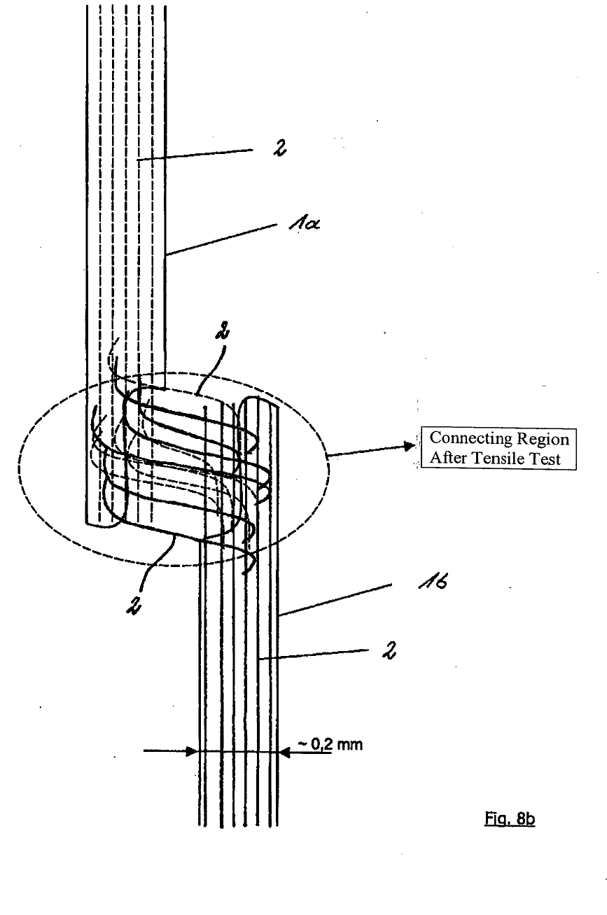

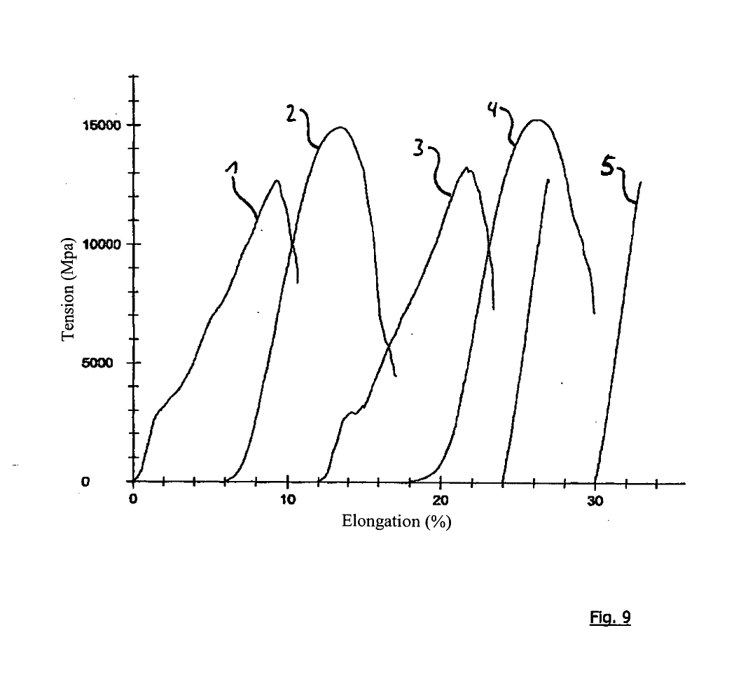

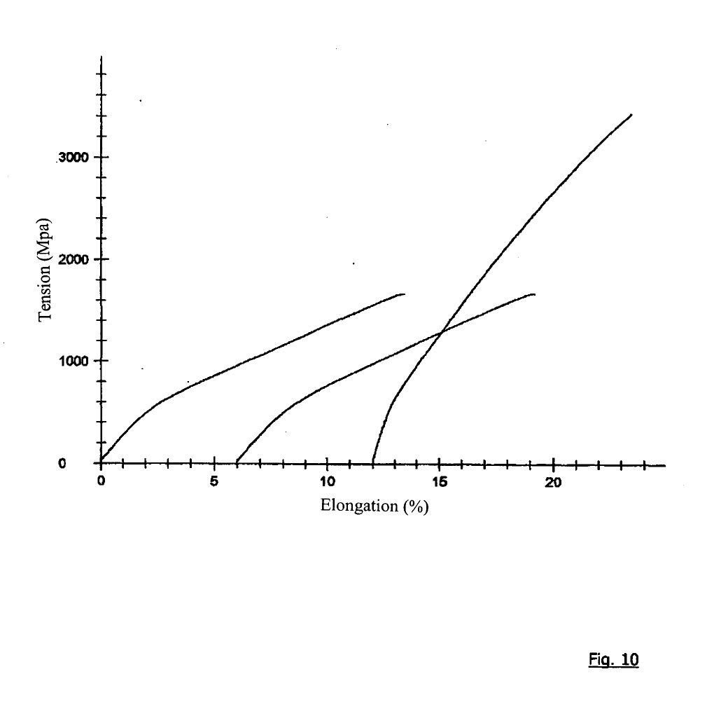

The tensile strengths of a conventional steel binding tape (FIG. 9), a conventional plastic strap (FIG. 10), and a plastic strap widely used for packing (FIG. 11) were tested in comparative tests.

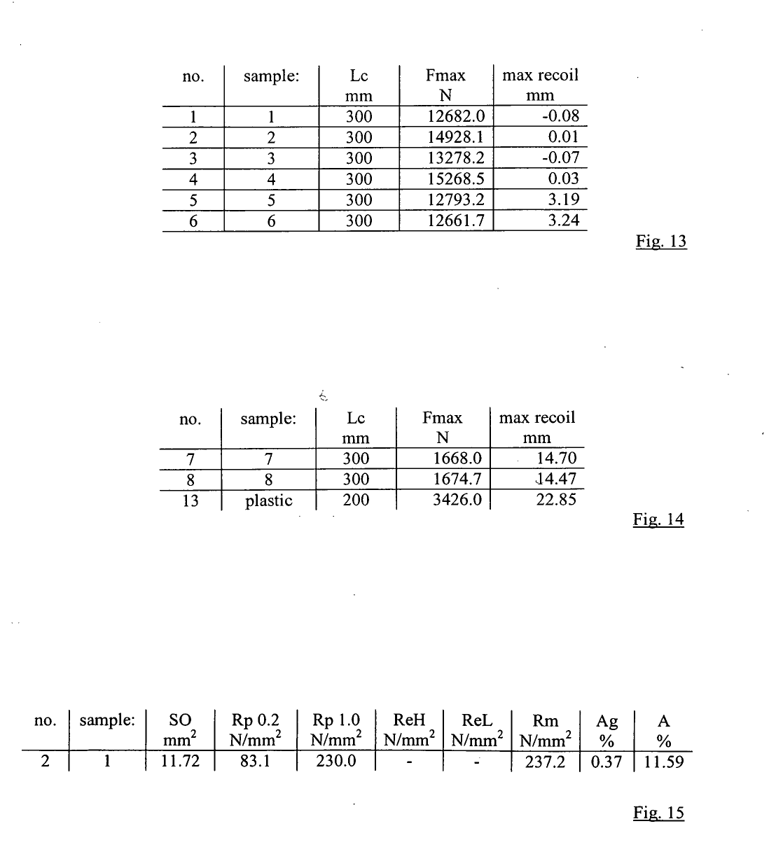

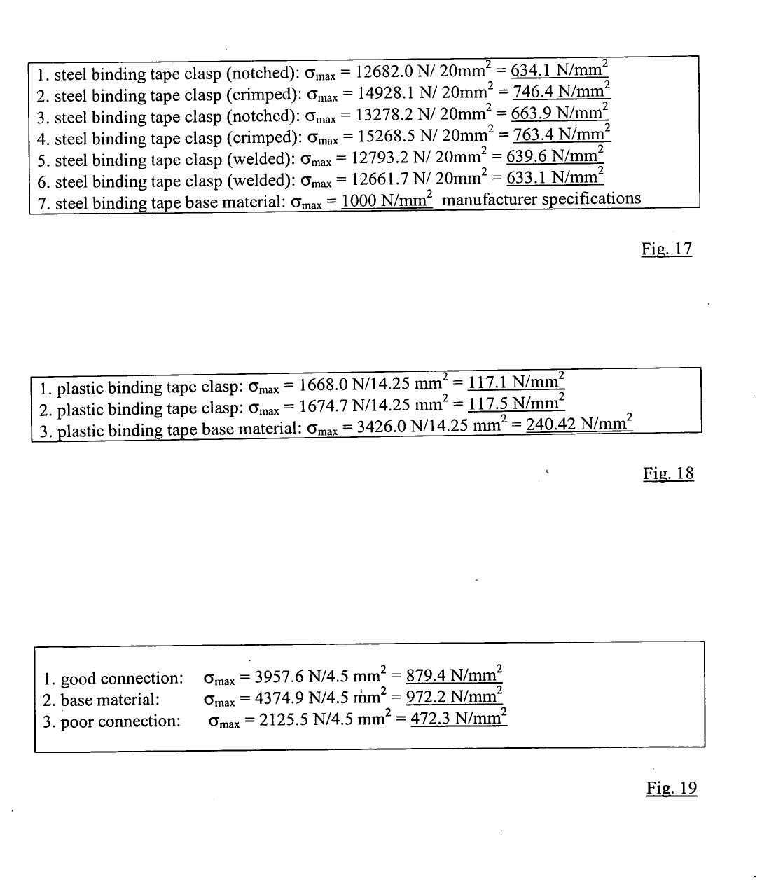

The tensile strengths for steel depicted in FIG. 9 are expressed in relation to the results in FIG. 13; in FIG. 17, the relative values are expressed in N/mm². In FIG. 17, the various attaching mechanisms are indicated and the corresponding tensile strengths are indicated for each. It is easy to see that the best steel connection is still worse than a good connection of the binding tape according to the invention; the base materials have approximately the same tensile strength. A comparison of FIGS. 13 and 16 shows that the tensile strength of steel when used in the form of steel binding tape with the usual dimensions is naturally higher than that of the material according to the invention, but in this case, a potential is kept in reserve that is not ever needed. The tensile strengths of the binding tape according to the invention are entirely sufficient for the desired purpose.

As indicated in FIG. 10, however, a conventional plastic strap demonstrates an elongation behavior that is undesirable and unsuitable for the specified purpose. In addition, the tensile strengths that are indicated in FIG. 18 and FIG. 14 are absolutely insufficient for the purpose of being used as a binding tape. In addition to these poor mechanical properties, this binding tape leaves behind binding tape indentations in the coil.

A conventional, intrinsically known packing strap with a width of 15 mm and a thickness of 0.8 mm was also tested. Straps of this kind are usually friction welded or equipped with binding tape clasps; these packing straps are usually used in the postal packaging sector, but partially also in the construction sector, e.g. for bricks and the like.

The tensile test in FIG. 11 shows that the elongation in this product is much too high for the performance required and also shows that this band has a tensile strength that comes nowhere near meeting the requirements. The result is shown in FIG. 15.

It is clear in summary that the binding tape according to the invention is in no way comparable to conventional plastic or steel straps. With a very slight thickness, it has a tensile strength that approximately corresponds to that of steel and a connection can easily be produced by means of heating and subsequent application of pressure. This tape leaves no binding tape indentations at all in the steel, even with the intentional exertion of powerful loads directly on the tape and the usual handling of steel coils during transport and storage. It is also advantageous that this binding tape can be cut without significant danger to a user since, due to its low weight, it does not recoil like a steel binding tape. Furthermore, its edges are not particularly sharp so that this binding tape also does not involve a pronounced danger of cutting people.

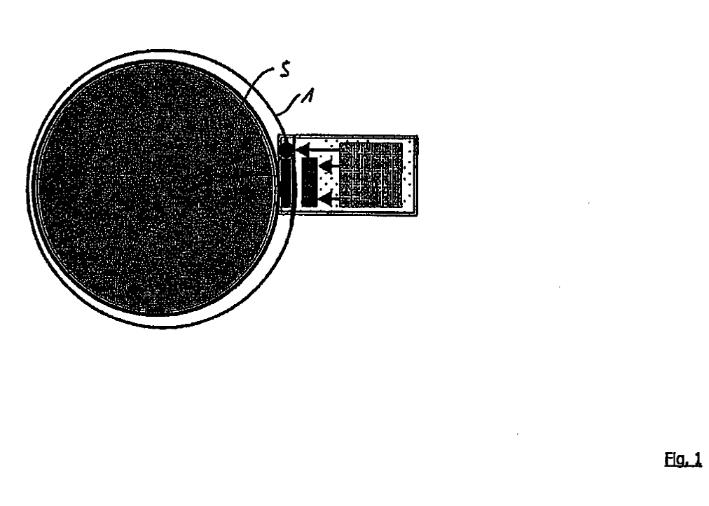

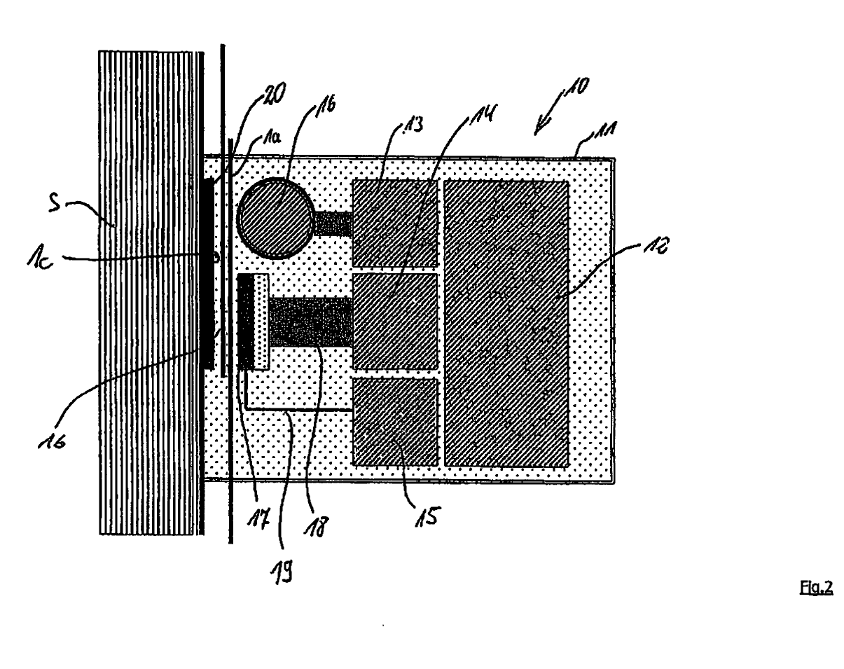

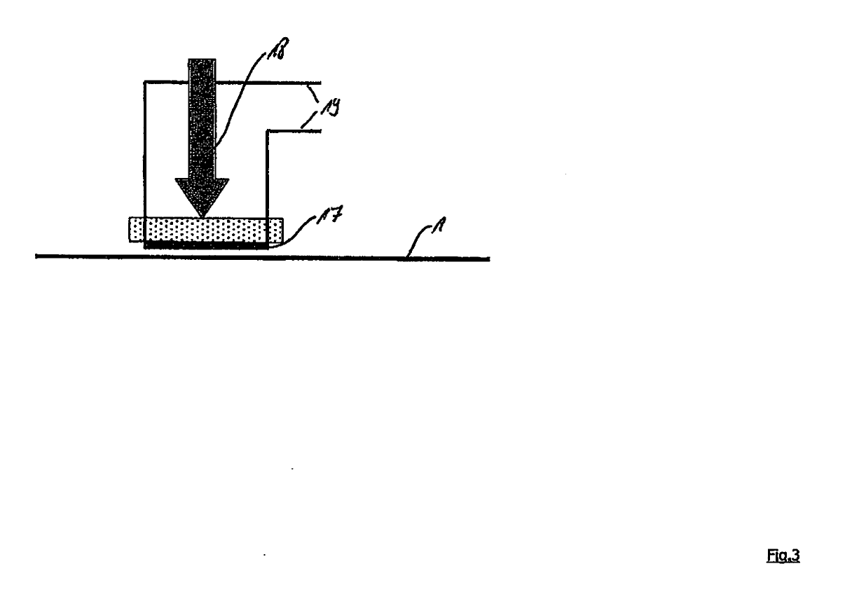

A device 10 according to the invention (FIGS. 1 through 5) is in principle constructed as follows (FIG. 2): a housing 11 contains a sequence control unit 12 that controls a force exertion unit 13, a pressing unit 14 for a heating element, and a heating control unit 15. In addition, the force exertion unit 13 is connected to a tensioning roller 16 with a corresponding motorized drive unit (not shown). The pressing unit 14 for exerting a pressing force is connected to a heating element or heating unit 17, which is connected to the unit 14 by means of a die 18. The heating control unit 15 is connected to the heating element 17 by means of a corresponding control and supply line 19. The device 10 according to the invention also has a counter-support plate 20.

In order to produce a welded connection according to the invention between two binding tape ends, a corresponding binding tape 1 according to the invention (FIG. 1) is placed around a steel coil S. The binding tape ends 1a, 1b are inserted into the device 10 laterally or from diametrically opposite sides, forming an overlapping region 1c. In the overlapping region 1c, on one side of the overlapping binding tape ends 1a and 1b, the counter-support plate 20 is situated parallel and planar to the binding tape ends 1a and 1b. The tensioning roller 16 is situated opposite from the counter-support plate; next to the tensioning roller 16, the heating element with the corresponding device for exerting a pressing force is also situated opposite the counter-support plate 20.

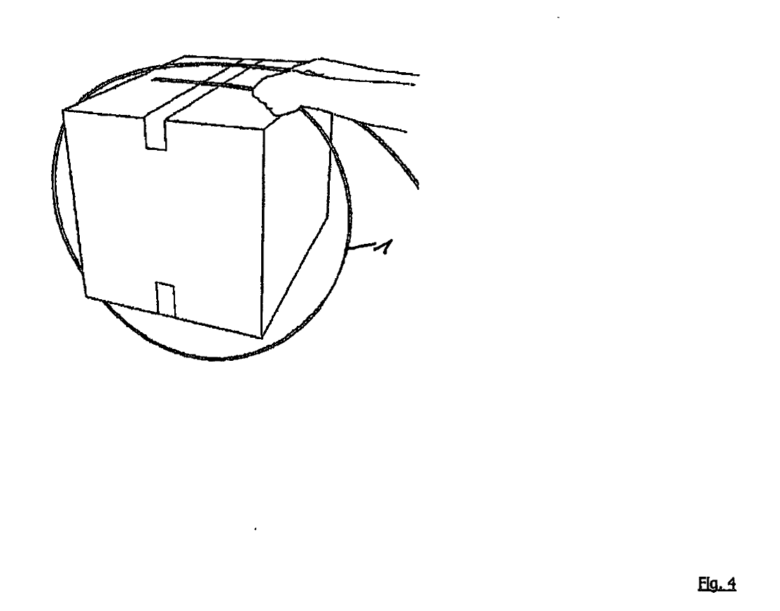

The binding tape according to the invention can also be manually placed around conventional packages that need to be secured against powerful tensile forces (FIG. 4).

In the method according to the invention, after the binding tape ends 1a and 1b overlap each other, the binding tape ends 1a and 1b are moved in relation to each other so as to tighten the binding tape. To this end, the force exertion unit 13 pushes the tensioning roller 16 onto a binding tape end 1a and begins to move so that the binding tape end 1a is moved in relation to the binding tape end 1b so that the overlapping region grows and tension is exerted on the binding tape 1. If the binding tape is sufficiently taut, then the sequence control unit 12 actuates the pressing unit 14 and/or the heating element 17 so that the die 18 brings the heating element 17 into contact with the binding tape ends 1a and 1b.

In this case, first, the heating element 17 can transmit heat to the binding tape ends and then a stroke of the piston or movement device 18 can be executed in order to press the binding tape ends 1a, 1b into each other when the matrix 3 is soft. Another possibility is to bring the heating element 17 into contact with the binding tape ends, then to heat it, and already during the heating, to exert the pressure or else to first carry out only a heating and then to exert the pressure. The device according to the invention can be situated in a coil tightening strap device at the end of a rolling line or coating line.

In another advantageous embodiment (FIG. 5), the device 10 is embodied as a handheld unit and can in particular be used for packages of the kind shown in FIG. 4 or for strapping coils manually.

In another advantageous embodiment, the device 10 has a receiving gap or slot for the binding tape ends 1a, 1b (not shown). In this case, the receiving gap or slot is either accessible from the side or has axial openings in the housing of the device 10 so that the binding tape ends 1a, 1b can be inserted into the slot from opposite axial ends.

The device 10 also has two pairs of tensioning rollers, which are situated spaced axially apart from the slot, with the tensioning rollers of a pair of tensioning rollers being situated opposite from each other on both sides of the slot. In the region between the two pairs of tensioning rollers, the counter-support plate 20 is situated bordering one side of the slot. The pressing unit 14 with the heating element 17 is situated opposite from the counter-support plate 20; the counter-support plate 20 and/or the pressing unit 14 can be slid toward or pressed against the respective opposing element.

In another advantageous embodiment, the counter-support plate 20 itself is embodied in the form of a second pressing device 14 with a second heating element 17 and both of the pressing units 14 can be moved toward and slid against each other.

With this device, in the method according to the invention, the binding tape ends 1a, 1b are either inserted laterally into the device or are inserted through openings in the housing of the device 10, which are arranged axially in relation to the slot, until the binding tape ends extend through both of the roller units. In order to tension the binding tape ends, the roller units are driven in rotating fashion and rotate in opposite directions. As a result, the binding tape ends are slid in opposite directions from each other, thus exerting tension on the binding tape. When a sufficient tension has been achieved, the heating element(s) is/are heated until the binding tape ends have reached a sufficient temperature in the region between the counter-support plate 20 and the pressing unit 14 or in the regions between the two pressing units 14 and the two heating elements 17. Then, the necessary pressure is exerted on the binding tape ends 1a, 1b by the pressing unit(s).

The device according to the invention has the advantage of being able to easily, quickly, and safely produce a connection of the binding tape ends.

The method according to the invention has the advantage of being able to carry out this method with significantly greater ease and speed than conventional methods for connecting binding tape ends and also has the advantage of not requiring the installation of clasps that on one hand represent a weak zone in terms of the strength of the binding tape and on the other hand, further exacerbate the binding tape indentations that are produced anyway by means of the normal binding tapes used.

The method according to the invention, the device according to the invention, and the binding tape according to the invention can naturally also be used with other packets or coils such as aluminum or copper coils, and for bundling pipes made of steel or other materials, sheet metal or plastic blanks or plates, etc.

1. A binding tape for strapping or binding metal packets or coils, the binding tape comprising continuous fibers and a plastic matrix; the continuous fibers are situated on top of one another in one or more layers and are oriented essentially parallel to one another and the plastic matrix comprises a thermoplastic material; and the binding tape has a width of 10 to 50 mm with a thickness of 100 to 400 μm.

2. The binding tape as recited in claim 1, wherein the binding tape has a width of 25 to 40 mm.

3. The binding tape as recited in claim 1, wherein the binding tape has a thickness of 200 to 350 μm.

4. The binding tape as recited in claim 1, wherein the fibers are glass fibers and/or aramide fibers and/or carbon fibers and/or metal fibers and/or natural fibers.

5. The binding tape as recited in claim 1, wherein the thermoplastic material in the matrix is a polyolefin and/or polyamide.

6. A method for bundling or strapping packets of rolled metal with a binding tape, the method comprising:
placing a binding tape around an object, in particular a steel coil, so that overlapping ends of the binding tape are formed with the ends of the binding tape lying one on top of the other, wherein the binding tape is made of a composite material composed of continuous fibers and a thermoplastic material and having a width of from 10 to 50 mm and a thickness of from 100 to 300 μm;
applying heat to the binding tape in the region of the overlapping ends so that the thermoplastic material softens; and
exerting pressure over the area of the softened thermoplastic region in such a way that the ends of the binding tape are pressed into each other thus forming a connecting region.

7. The method as recited in claim 6, comprising heating the overlapping ends of the binding tape to a temperature of 100 to 500° C.

8. The method as recited in claim 6, wherein the temperature of the heat applied to the binding tape is matched to the softening point of the thermoplastic material.

9. The method as recited in claim 6, comprising exerting a pressure of 0.1 N/mm² to 10 N/mm² to the softened binding tape ends.

10. The method as recited in claim 6, further comprising using a tensioning device to tension the binding tape before applying heat to the binding tape; and, after applying heat to the binding tape, pressing the ends of the binding tape together, and cooling the connecting region, then cutting off binding tape end regions that protrude beyond the connecting region.

11. The method as recited in claim 6, comprising subjecting the overlapping binding tape ends to heat and pressure in a region of a free binding tape end so that no protruding ends are produced.

12. The method as recited in claim 6, further comprising tensioning the binding tape ends using friction rollers that act on the binding tape ends or using tensioning elements that engage the binding tape ends.

13. A device for carrying out the method as recited in claim 6, comprising:
a heating unit that imparts heat to ends of a binding tape; and
a pressing unit for exerting pressure over the heated region of the binding tape.

14. The device as recited in claim 13, further comprising a tensioning device that tensions the binding tape ends in relation to each other.

15. The device as recited in claim 14, comprising two tensioning devices, which are spaced apart from each other in relation to a longitudinal span of a binding tape to be inserted, and between the tensioning devices, one or more pressing units and heating units are provided so that it is possible to exert pressure and heat on the binding tape ends between the tensioning devices.

16. The device as recited in claim 14, wherein the tensioning device is designed to act on the binding tape ends in such a way that the binding tape is tightened; the heating unit and the pressing unit are situated in the region of each of the binding tape ends so that it is possible to press the binding tape ends onto the binding tape underlying them without leaving protruding ends and produce two binding regions that are spaced apart from each other.

17. The device as recited in claim 13, wherein each pressing unit for exerting a pressing force is connected to a respective heating unit.

18. The device as recited in claim 13, wherein the heating unit is connected to the device via a die while a control unit is connected to the heating unit via a corresponding control and supply line.

19. The device as recited in claim 13, wherein the device has heating units and pressing units situated opposite from each other in relation to the thickness of the binding tape or binding tape ends so that in a region of a planned connecting point, it is possible to exert heat and pressure on the binding tape from both sides.

20. The device as recited in claim 13, wherein a plurality of the heating units and the pressing units that respectively cooperate with one another are provided so that it is possible to produce a plurality of connecting points in the overlapping region of the binding tape ends.

21. The device as recited in claim 13, wherein the device is a handheld unit.

22. The device as recited in claim 13, wherein the device is mounted in stationary fashion on a winding device for metal straps.

23. The device as recited in claim 13, further comprising two pairs of tensioning rollers that are situated spaced axially apart from each other along a receiving slot for the binding tape ends; in a region between the two pairs of tensioning rollers, a counter-support plate is situated bordering one side of the slot; the pressing unit and the heating unit are situated opposite from the counter-support plate; and the counter-support plate and/or the pressing unit has the capacity to be slid or shifted toward the respective opposing element.
